(19) United States
(12) Patent Application Publication
(10) Pub. No.: US 2014/0087573 A1
(43) Pub. Date: Mar. 27, 2014

(54) Leading ground contact with the aid of a spring element

(71) Applicant: Markus Kroeckel, Schwieberdingen (DE)

(72) Inventor: Markus Kroeckel, Schwieberdingen (DE)

(21) Appl. No.: 14/009,830

(22) PCT Filed: Feb. 29, 2012
(86) PCT No.: PCT/EP2012/053431

§ 371 Date: Dec. 6, 2013

(30) Foreign Application Priority Data
Apr. 6, 2011 (DE) 10 2011 006 834.1

(51) Int. Cl. H01R 13/652

(52) U.S. Cl. CPC H01R 13/652
USPC 439/96

(57) ABSTRACT

A plug connector for connecting to a complementary plug connector includes: at least one electrical contact element for connecting to an electrical contact element of the complementary plug connector; and a spring element electrically connected to a ground line of the plug connector. The plug connector is configured in such a way that during the connection of the plug connector to the complementary plug connector, the spring element electrically contacts a ground contact element of the complementary plug connector, before the electrical contact element of the plug connector contacts the electrical contact element of the complementary plug connector.

### BACKGROUND OF THE INVENTION

1. Field of the Invention

The present invention relates to an electrical plug connector, an electrical plug connection, and a method for connecting a plug connector to a complementary plug connector.

2. Description of the Related Art

An electrical plug connection generally includes two electrical plug connectors, which are plugged one inside the other, to establish an electrical connection between electrical contact elements of one plug connector and the electrical contact elements of the other plug connector. Normally, one electrical plug connector is designed as a plug or as a socket and the other electrical plug connector is designed as a socket or a plug complementary thereto. A socket is to be understood as a plug connector which has an opening or a cavity, which is designed for the purpose of accommodating the plug.

In the case of electrical plug connectors, which are used for the purpose of connecting electronic components to one another or connecting an electronic component to its power supply, designing a ground contact as a so-called leading ground contact is known. A ground contact is an electrical contact between two contact elements, which are connected to the ground potential, which is generally 0 V, or between two lines which are to conduct the ground potential. A leading ground contact is designed in such a way that, when the plug connectors are plugged together, it establishes the electrical ground contact before other electrical contact elements of the plug connection come into contact with one another. In this way, electronic circuits may be prevented from being energized before they are connected to the ground potential. Damage to the electronic circuits may thus be prevented, if the plug connection is established and lines are already supplied with voltage.

Various approaches are known from the related art for leading ground contacts. For example, one of the plug connectors may include pins, i.e., small rods made of an electrically conductive material, as contact elements and the other plug connector may include receptacles complementary thereto for the pins. A leading ground pin may now be produced by the ground pin being designed to be longer than the other pins, the receptacle for the ground pin being lengthened or being displaced in relation to the other receptacles in such a way that its front edge protrudes beyond the front edges of the other receptacles.

In the case of plug connections in which one plug connector includes a circuit board, on which the electrical contact elements are designed as printed conductors, i.e., as so-called “lands,” providing a leading ground contact by the land connected to the ground potential protruding beyond the lands for the other electrical contacts in the plug direction is also known.

All of the above-mentioned approaches may have the disadvantage that they must be expensively retrofitted during the retrofitting of existing projects which use the plug connection.

Special contacts or special contact elements such as pins, receptacles, or lands are also generally necessary, using which the leading ground contact is implemented. Since the corresponding contact element differs from the other electrical contact elements, it is subjected during the plugging together to different mechanical strains than the remaining contact elements, which may result in increased susceptibility to wear of the leading ground contact.

The lengthening of the ground contact element may also have the result that an installation space enlargement results in the plug direction in the case of the plug connection or the affected plug connector.

In the case of plug connections which include a circuit board, damage to the electrical contacts, which are not designed to be leading, may additionally occur during the plugging together of the plug connection, since the front edge of the circuit board in the case of these contacts is farther away from the front edges of the lands than in the case of the leading ground lands.

### BRIEF SUMMARY OF THE INVENTION

The object of the present invention is therefore to provide an electrical plug connection, in which a leading ground contact is present, without the ground contact being subjected to increased wear and without enlarging the installation space of the plug connection in the plug direction.

A first aspect of the present invention relates to an electrical plug connector for connecting to a complementary electrical plug connector. The plug connector may be a plug or a socket and may also include pins or receptacles for pins as electrical contact elements. It is also possible that the plug connector includes a circuit board, which has the electrical contact elements as printed conductors, or the plug connector includes clamps, which are designed for the purpose of contacting the lands of a circuit board.

Overall, it is possible that the plug connector has a plurality of electrical contact elements for connecting to electrical contact elements of the complementary plug connector. These electrical contact elements are generally all designed identically, for example, pins of equal length or receptacles of equal length or identically designed receptacles for pins or identically designed lands on a circuit board.

According to one specific embodiment of the present invention, the plug connector has a spring element, which is electrically connected to a ground line of the plug connector. The plug connector is designed in such a way that during the connection of the plug connector to the complementary plug connector, which is generally carried out by pushing together or plugging together the two plug connectors, the spring element electrically contacts a ground contact element of the complementary plug connector. Vice versa, the complementary plug connector may have a contact element, which is electrically connected to a ground line and which is designed in such a way that it may touch the spring element during the plugging together or connecting of the plug connection. The contacting of the spring element with the ground contact element of the complementary plug connector occurs before another electrical contact element of the plug connector contacts a corresponding electrical contact element of the complementary plug connector. In this way, a ground contact is established via the spring element and the ground contact element of the complementary plug connector before the other electrical contacts of the plug connection are established.

A ground line is to be understood as a line which has a ground potential when it is connected to a corresponding voltage source or when the power supply is turned on.

The use of a spring element for establishing the ground contact may have the advantage that lengthened contact elements do not have to be used for the plug connector, whereby installation space may be saved. In addition, the mechanical stress of a spring element, because it may easily spring back and is deformable, is not as great as in the case of rigid electrical contact elements. The hazard is thus reduced of damaging the leading ground contact of the plug connector, and the mechanical wear of the plug connector is also reduced.

According to one specific embodiment of the present invention, the electrical contact elements are applied as printed conductors to a circuit board, which is an integral part of the plug connector. In particular in the case of a plug connector designed in this way, the electrical contact elements may all be designed identically, which has the result that when the plug connector is plugged together with a corresponding plug connector, the electrical contact elements are all mechanically stressed equally, which results in uniform wear.

According to one specific embodiment of the present invention, the electrical contact elements of the plug connector are enclosed by a bush. In other words, the plug connector may include a socket. In the case of such a plug connector, the spring element may be attached to an inner wall of the bush, so that in addition to the electrical contact elements, the spring element is also protected by the bush when the plug connector is not connected to the other component, i.e., the plug of the plug connection.

According to one specific embodiment of the present invention, it is alternatively possible that the plug connector includes a plug, i.e., it is designed for the purpose of being plugged into a corresponding socket. In this case, the spring element may protrude outward from the plug, for example, orthogonally to the plug direction, for example. In this case, it is possible that the complementary plug connector has a ground contact element, which is connected to the ground line of the complementary plug connector, the ground contact element being attached to an inner wall of a bush of the complementary plug connector. The attachment of the spring element to the plug and not in the socket may be advantageous, for example, if the socket is to be constructed as simply as possible.

According to one specific embodiment of the present invention, the plug connector may also have, in addition to the spring element, a ground contact element for connecting to a ground contact element of the complementary plug connector. For example, this ground contact element may be constructed precisely like the other electrical contact elements of the plug connector and nonetheless a leading ground contact may be established by the spring element. The additional ground contact element may have the advantage that the spring element for establishing the ground contact must only establish the electrical connection between the two ground lines of the plug connector and the complementary plug connector during the plugging together. If the plug connector has been plugged completely into the complementary plug connector or connected thereto, the ground contact may be established using the additional ground contact element, additionally or alternatively to the spring element.

According to one specific embodiment of the present invention, the spring element includes a contact pressure spring for pressing the ground contact element of the plug connector onto the ground contact element of the complementary plug connector. In this way, it is not necessary for the plug connector to include an additional spring element for establishing the ground contact. The already provided contact pressure spring may simply be used for this purpose.

For example, the plug connector may be an interface to a circuit board, which may include electronic components and which includes the electrical contact elements as printed conductors on the edge of the circuit board. Such an interface may include a bush, which is manufactured from plastic, for example, which is attached to the edge of the circuit board, and which encloses electrical contact elements, i.e., lands. Such an interface generally has at least one spring element for each electrical contact element, which is used for the purpose of pressing an electrical contact element of the plug, which is plugged into the interface, onto the land of the circuit board. The contact pressure elements protrude from the inner wall orthogonally to the plug direction, for example. The plug is generally connected to a cable harness, which connects the electronic circuits on the circuit board to further components.

An electrically conductive contact pressure spring may be connected, for the ground contact element of the interface, to the ground potential of the circuit board or the ground potential of the interface. Vice versa, the position of the carrier of the electrical contact element of the plug, against which the contact pressure spring presses, when the plug is plugged into the interface, may also be provided with an electrical contact element which is connected to the ground line of the plug. The spring element may be attached at a position in the interface at which the contact between the contact pressure spring and the ground contact element of the plug occurs, before the other electrical contact elements of the plug touch the contact elements on the circuit board, i.e., for example, the lands, during the insertion of the plug into the interface. In this way, a leading ground contact is created, without the above-described problems having to arise.

Such a construction also has the additional advantage that the EMC shielding (i.e., the electromagnetic shielding) of the plug connection is improved, since at least the ground potential is shielded by the leading spring element, which is at ground potential.

In the above-described system composed of an interface for a circuit board and a plug, the principle according to the present invention may also be applied if an electrically conductive spring element is installed on the plug side. In this case, a ground contact element may be provided on the interface, for example, a rigid contact element which is injection-molded into the interface collar wall, i.e., the inner side of the bush, for example.

In general, a leading ground contact via a spring element is always possible if a contact pressure element is already provided between two electrical contact elements, for example, a contact carrier and an electrical printed conductor of the interface. Such contact pressure elements are generally made of metal and are therefore electrically conductive.

However, it is also possible that the spring element is not a contact pressure element, but rather a separately attached spring element. For example, this may be an injection-molded spring element on the interface collar, which may contact a ground contact element on the cable harness plug.

Another aspect of the present invention also relates to a plug connection, which includes a plug connector and a complementary plug connector, as described above and hereafter.

Another aspect relates to a method for connecting a plug connector to a complementary plug connector. The plug connector and the complementary plug connector may again be plug connectors as described above and hereafter.

According to one specific embodiment of the present invention, the method includes the following steps: electrically contacting a spring element, which is connected to the ground line of the plug connector, to a ground contact element of the complementary plug connectors; subsequently electrically contacting at least one electrical contact element of the plug connector to a complementary electrical contact element of the complementary plug connector. In other words, the leading ground contact is established via a spring element and not via a rigid ground contact element, which is generally constructed similarly as the other electrical contact elements of the plug connector. It is to be understood that the plug connectors may be designed in such a way that the method steps are carried out during the plugging of one connector into the other plug connector.

Exemplary embodiments of the present invention will be described in greater detail hereafter with reference to the appended drawings.

### BRIEF DESCRIPTION OF THE DRAWINGS

FIG. 1A shows a plug connection according to a first specific embodiment of the present invention in a decoupled position.

FIG. 1B shows the plug connection according to the specific embodiment of FIG. 1A in a coupled position.

FIG. 2A shows a plug connection according to a second specific embodiment of the present invention in a decoupled position.

FIG. 2B shows the plug connection according to the specific embodiment of FIG. 2A in an intermediate position.

FIG. 2C shows the plug connection according to the specific embodiment of FIGS. 2A and 2B in a coupled position.

### DETAILED DESCRIPTION OF THE INVENTION

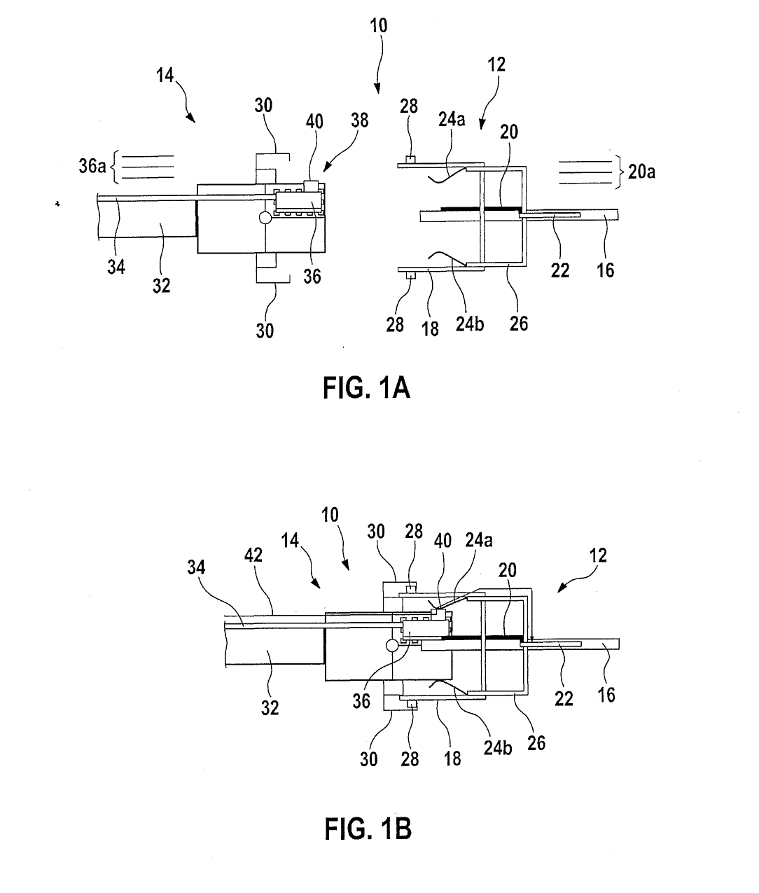

FIG. 1A shows a plug connection 10 in a longitudinal section. Plug connection 10 includes a socket 12 and a plug 14. Socket 12 is an interface for a circuit board 16, on whose edge a bush 18 is attached, which encloses the edge of circuit board 16. An electrical contact element 20 in the form of a printed conductor 20, which is connected to schematically shown ground potential 22 on the circuit board, is situated on circuit board 16. A first conductive spring element 24a and a second conductive spring element 24b are attached in each case on the inner side of bush 18 or on the interface collar wall above and below circuit board 16. Spring elements 24a, 24b may be leaf springs made of a metal strip, for example. As schematically shown in FIG. 1A, the two spring elements 24a, 24b are connected via lines 26 to ground potential 22. However, it is also possible that only lower spring element 24b or upper spring element 24a is connected to ground potential 22.

In addition, socket 18 has on its outer side a projection 28, which may engage behind a corresponding clamp element 30 of plug 14 to fix plug 14 on socket 12.

Plug 14 is connected to a cable harness 32, which has a line 34, which is to be connected to ground potential 22. In other words, line 34 is the ground line of cable harness 32 or of plug 14. Plug 14 also includes a contact carrier 36, which includes electrical contact element 38, which is to come into contact with printed conductor 20 after the two plug connectors 12, 14 are plugged together. For example, contact carrier 36 may be made completely of metal and may be connected to electrical line 34 or contact carrier 36 may also be made of plastic, in which electrical contact element 38, which is electrically connected to line 34, is molded.

On its upper side, contact carrier 36 has a superelevation 40, which is electrically conductive and is also connected to ground line 34. This superelevation 40 may also be molded in a contact carrier 40, if it is made of plastic.

FIG. 1B shows plug connection 10 in a plugged-together state, in which plug 14 is pushed completely into socket 12. As is apparent from FIG. 1B, clamp 30 engages behind edge 28 on socket 12 and thus prevents plug 14 from falling out of socket 12. In addition, spring element 24b presses from below against plug 14 and spring element 24a presses from above on contact carrier 26, especially on superelevation 40. Therefore, on the one hand, an electrical connection is provided between line 34 via superelevation 40 and spring element 24a to ground potential 22 and, on the other hand, an electrical connection is provided directly from line 34 via contact carrier 36, which is pressed by spring element 24a onto printed conductor 20.

The electrical connection between line 34 and ground potential 22 on circuit board 16 is schematically indicated in FIG. 1B by arrow 42.

Spring element 24a is situated in socket 12 in such a way that when plug 14 and socket 12 are plugged together, spring element 24a comes into contact with superelevation 40 before contact carrier 36 touches printed conductor 20.

Overall, it is to be understood that plug connection 10 or socket 12 and plug 14 have a plurality of electrical contacts, as shown in the cross section in FIGS. 1A and 1B. Only the electrical contact elements for the ground contact are shown in FIGS. 1A and 1B. A further number of analogously or identically or similarly constructed contact elements may also be situated in socket 12 and plug 14 in front of or behind the plane of the figure, in the case of which spring element 24a or spring element 24b is not connected to corresponding electrical line 22. Similarly, for these other electrical contact elements, the contact carriers, which correspond to contact carrier 36, do not have superelevations 40, which are electrically conductive or are connected to the line corresponding to line 34.

Further electrical contact element 36a of plug 14 and further contact elements 20a of socket 12 are indicated by dashes in FIG. 1A.

Due to this system, when plug 14 and socket 12 are pushed together, initially a ground contacting takes place between spring element 24a and superelevation 40, before the other electrical contacts occur, for example, the contact between printed conductor 20 and contact carrier 36 and corresponding other electrical contacts 36a, 20a of the electrical plug connection.

In the end position of plug connection 10 shown in FIG. 1B, the short circuit to ground occurs via spring or spring element 24a. In addition, the short circuit to ground may also occur via associated land 20 of contact 36, 20 or run via another contact 36a, 20a.

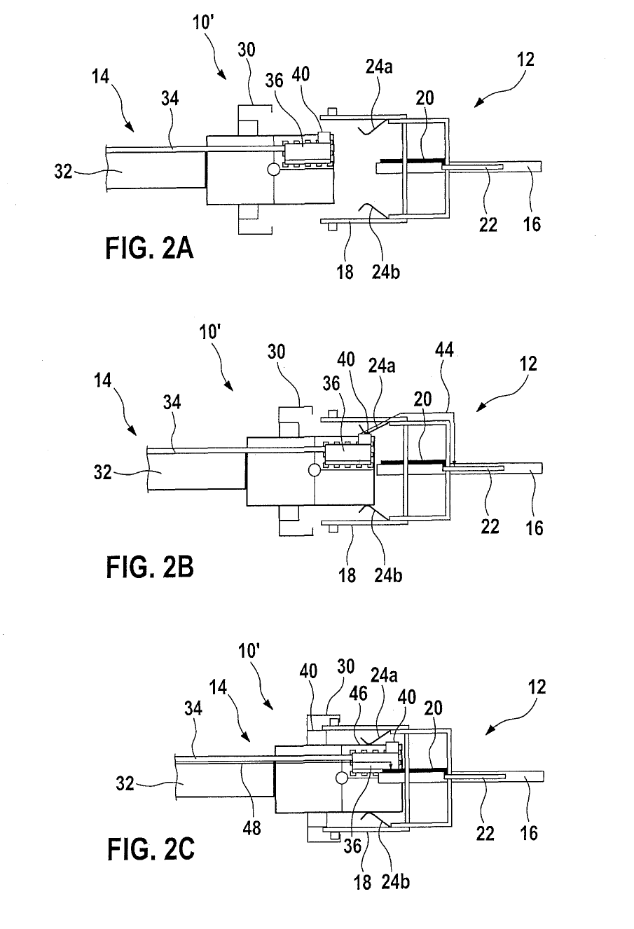

FIGS. 2A, 2B, and 2C show another specific embodiment of a plug connection 10′, whose socket 12 and plug 14 are constructed essentially identically to the specific embodiment which is shown in FIGS. 1A and 1B. However, in the specific embodiment shown in FIGS. 2A through 2C, superelevation 40 and spring element 24a are situated in such a way that a temporary leading ground contact is established via their contacting.

FIG. 2A shows plug connection 10′ or plug system 10′, which includes plug connectors 12, 14, in a position in which the plugging is directly imminent. Neither spring element 24a nor printed conductor 20 or land 20 is connected to contact carrier 36 in this first step.

FIG. 2B shows plug connection 10′ in an intermediate position, which lies between the position shown in FIG. 2A and the position shown in FIG. 2C, in which plug 14 has not yet been pushed completely into socket 12. In this second step, spring 24a has already contacted superelevation 40 and therefore contact carrier 36, so that a ground contact already exists via spring element 24, but the contacting of printed conductor 20 with contact carrier 36 has not yet taken place. The ground contact via spring element 24a or contact pressure spring 24a is schematically shown in FIG. 2B by arrow 44.

In a third step, which occurs in a position of plug connection 10′ which is to be placed between FIGS. 2B and 2C, the ground contact still exists between contact pressure spring 24a and superelevation 40 and contacting takes place between printed conductor 20 and contact carrier 36, so that both ground contacts exist simultaneously.

In a fourth step, in which plug 14 has been inserted completely into socket 12, the electrical connection between contact pressure spring or spring element 24a and superelevation 40 is disconnected and the ground contact between contact carrier 36 and printed conductor 20 remains in existence. In the position shown in FIG. 2C, the end position of plug 14 in socket 12 is reached. Spring element 24a no longer presses against electrically conductive superelevation 40, but rather against an insulating element 46 of plug 14. A ground contact only still exists between ground potential 22 on circuit board 16 and line 34 via the contact between contact carrier 36 and printed conductor 20. This is schematically shown in FIG. 2C by arrow 48.

Alternatively to the described sequence, the contact element may also completely relinquish the ground contact after losing the contacting by contact pressure spring or spring element 24a, if previously other contact elements of plug connection 10 are already contacted and ground contacts are also situated among them. Therefore, a land 20 would also not be required for the temporary contact on circuit board 16. The contact element is solely designed for the purpose of establishing a ground contact between spring element 24a and contact carrier 36. In this case, the leading ground contact of this contact element would be viewed as completely temporary. The leading ground contact only occurs temporarily during the plugging together. After the plugging together, no electrical contact is present.

In contrast to the specific embodiment shown in FIGS. 1A and 1B, the short circuit to ground of plug connection 10′ in the end position, which is shown in FIG. 2C, exclusively occurs via the standard contact between contact carrier 36 and printed conductor 20. This has the advantage that the leading ground contact is not permanent and therefore does not have to be subject to dynamic wear. In this way, the contact point on spring element 24a does not have to be optimized with respect to a permanent ground contact. Therefore, a design of spring element 24a as a contact element may be avoided, which could be complex and could possibly limit plug connection 10′ with respect to its dynamic carrying capacity.

1-10. (canceled)

11. A primary plug connector for connecting to a complementary plug connector, comprising:
at least one electrical contact element for connecting to an electrical contact element of the complementary plug connector; and
a spring element electrically connected to a ground line of the primary plug connector;
wherein the primary plug connector is configured to enable, during the connection of the plug connector to the complementary plug connector, the spring element to electrically contact a ground contact element of the complementary plug connector, before the electrical contact element of the plug connector contacts the electrical contact element of the complementary plug connector.

12. The primary plug connector as recited in claim 11, further comprising:
a circuit board on which the at least one electrical contact element is applied as a printed conductor.

13. The primary plug connector as recited in claim 11, further comprising:
a bush which encloses the at least one electrical contact element.

14. The primary plug connector as recited in claim 13, wherein the spring element is attached on an inner wall of the bush.

15. The primary plug connector as recited in claim 11, wherein the plug connector includes a plug, and wherein the spring element electrically contacts the ground contact element of the complementary plug connector which is connected to a ground line of the complementary plug connector, the ground contact element being attached to an inner wall of a bush of the complementary plug connector.

16. The primary plug connector as recited in claim 11, further comprising:
a ground contact element for connecting to the ground contact element of the complementary plug connector;
wherein the spring element includes a contact pressure spring for pressing the ground contact element of the primary plug connector onto the ground contact element of the complementary plug connector.

17. The primary plug connector as recited in claim 11, wherein the primary plug connector is configured to enable the spring element to only electrically contact the ground contact element of the complementary plug connector during the plugging together of the primary plug connector with the complementary plug connector.

18. The primary plug connector as recited in claim 11, further comprising:
a ground contact element for connecting to the ground contact element of the complementary plug connector;
wherein the primary plug connector is configured to enable the ground contact element to contact the ground contact element of the complementary plug connector after the spring element has contacted the ground contact element of the complementary plug connector.

19. A plug connection system, comprising:
a primary plug connector; and
a complementary plug connector;
wherein the primary plug connector is configured for connecting to the complementary plug connector, the primary plug connector including:
at least one electrical contact element for connecting to an electrical contact element of the complementary plug connector; and
a spring element electrically connected to a ground line of the primary plug connector;
wherein the primary plug connector is configured to enable, during the connection of the plug connector to the complementary plug connector, the spring element to electrically contact a ground contact element of the complementary plug connector, before the electrical contact element of the plug connector contacts the electrical contact element of the complementary plug connector.

20. A method for connecting a primary plug connector to a complementary plug connector, comprising:
electrically contacting a spring element, which is connected to a ground line of the primary plug connector, with a ground contact element of the complementary plug connector; and
subsequently electrically contacting at least one electrical contact element of the primary plug connector with a complementary electrical contact element of the complementary plug connector.
